(19) United States
(12) Patent Application Publication
(10) Pub. No.: US 2026/0285574 A1
(43) Pub. Date: Sep. 24, 2026

(54) MULTI-COMPARTMENT POUCH APPARATUS AND METHODS OF MANUFACTURE

(71) Applicant: ALUBaby Inc., Whittier, CA (US)

(72) Inventors: Victor Burtea, Irvine, CA (US); Alexander Burtea, Ladera Ranch, CA (US); Daniel Burtea, Whittier, CA (US)

(73) Assignee: ALUBaby Inc., Whittier, CA (US)

(21) Appl. No.: 19/687,384

(22) Filed: May 26, 2026

Related U.S. Application Data
(63) Continuation-in-part of application No. 19/214,361, filed on May 21, 2025.
Application No. 19/214,361 is a continuation-in-part of application No. 18/506,661, filed on Nov. 10, 2023, now abandoned.

(51) Int. Cl. B65D 81/32; A61J 9/00; A61J 9/08; A61J 11/04

(52) U.S. Cl. CPC B65D 81/3266; A61J 9/005; A61J 9/085; A61J 11/04; B65D 2401/15

(57) ABSTRACT

A multi-compartment pouch apparatus is disclosed. In at least one embodiment, a pouch portion is constructed out of two sheets of laminate material constructed out of a PE innermost layer, a PA second layer, an AL third layer, and a PET outermost layer, with a pouch cavity defined between the two sheets of laminate material. A frangible seal spans a perimeter edge of the laminate material so as to divide the pouch cavity into a first compartment containing a first substance and a separate second compartment containing a second substance. A spout is in fluid communication with the pouch cavity, and a cap is removably engageable with the spout. During use, upon external manual pressure being applied to the first or second compartment, the frangible seal separates, turning the first and second compartments back into the single pouch cavity, and causing the first substance to mix with the second substance.

### RELATED APPLICATIONS

This is a continuation-in-part application and so claims the benefit pursuant to 35 U.S.C. § 120 of a prior filed and co-pending U.S. non-provisional patent application Ser. No. 19/214,361, filed on May 21, 2025, which itself is a continuation-in-part of U.S. non-provisional patent application Ser. No. 18/506,661, filed on Nov. 10, 2023. The contents of the aforementioned applications are incorporated herein by reference.

### BACKGROUND

The subject of this patent application relates generally to food and beverage containers, and more particularly to a multi-compartment pouch apparatus configured for being a sterilized, tamper-evident, all-in-one, ready-to-feed, disposable, single-use container, along with associated methods of manufacture.

Applicant hereby incorporates herein by reference any and all patents and published patent applications cited or referred to in this application.

By way of background, infant formula is typically a granulated or powder product packaged dry in a container. It is often difficult to use the container and dispense the powder formula from the container. Once the container is opened, the powdered formula is often packed into parts of the interior of the lid or top of the container, which results in waste. While some of the powder may fall back into the interior of the container, much of it is wasted and contaminated as it spills onto the surrounding workspace. Additionally, prior art containers may allow the contents to become contaminated.

Pouches configured for holding liquids are well-known in the prior art patent literature. For example, U.S. Pat. No. 7,810,677 discloses a flexible pouch defining a variable volume storage chamber and one-way valve assembly for aseptically storing a substance, dispensing multiple portions of the stored substance therefrom in cooperation with a pump, and maintaining substance remaining in the pouch in an aseptic condition sealed with respect to ambient atmosphere. The one-way valve includes a valve seat and elastic valve cover portion overlying the valve seat forming an interference fit therewith defining a normally-closed seam therebetween. The valve portion is movable radially between (i) a normally closed position with the valve portion engaging the valve seat, and (ii) an open position with at least a segment of the valve portion spaced radially away from the valve seat to allow substance from the storage chamber through the valve opening. The one-way valve maintains substance remaining in the variable-volume storage chamber in an aseptic condition sealed with respect to the ambient atmosphere.

Containers specialized for infant formula have also been described. For example, US20140299598 describes a container comprising: a body having a bottom and a side wall defining a reservoir; a collar attached to a top end of the body; a removable seal at the top end of the body to seal the reservoir; and, a lid hingedly engaged with the collar, the lid having an underside and configured to provide a docking station on the underside for holding a measuring device.

Nevertheless, convenient containers for holding powdered infant formula have continued to be elusive. Aspects of the present invention fulfill these needs and provide further related advantages as described in the following summary.

It should be noted that the above background description includes information that may be useful in understanding aspects of the present invention. It is not an admission that any of the information provided herein is prior art or relevant to the presently claimed invention, or that any publication specifically or implicitly referenced is prior art.

### SUMMARY

Aspects of the present invention teach certain benefits in construction and use which give rise to the exemplary advantages described below.

The present invention solves the problems described above by providing a multi-compartment pouch configured for being a sterilized, tamper-evident, all-in-one, ready-to-feed, disposable, single-use container in at least one embodiment. In at least one embodiment, a pouch portion is constructed out of a first sheet and an opposing second sheet of a substantially flat, flexible laminate material secured to one another about a sealed perimeter edge thereof, the first sheet and second sheet of laminate material cooperating to define a pouch cavity therebetween. The laminate material comprises an innermost layer constructed out of a polyethylene material configured for being heat-sealable, biocompatible for food contact, and providing a compliant interface that is capable of being welded reproducibly; a second layer, adjacent to the innermost layer, constructed out of a polyamide material configured for providing puncture resistance, tear resistance, and flexural toughness to the laminate material; a third layer, adjacent to the second layer, constructed out of an aluminum foil material configured for providing an oxygen barrier and light barrier to the laminate material; and an outermost layer, adjacent to the third layer, constructed out of a polyethylene terephthalate material configured for providing tensile strength, dimensional stability under heat, and resistance to creep to the laminate material. A frangible seal spans the perimeter edge of the first sheet and second sheet of laminate material so as to divide the pouch cavity into a first compartment and a separate second compartment, the frangible seal formed as a heat seal between the innermost layer of each of the first sheet and second sheet of laminate material, without use of any adhesive materials, such that an interfacial bond between the innermost layer of each of the first sheet and second sheet of laminate material is structurally weaker than a cohesive strength of each innermost layer and of the sealed perimeter edge. The first compartment contains a volume of a first substance, while the second compartment contains a volume of a second substance. An at least one spout is in fluid communication with the pouch cavity for selectively dispensing the first substance and second substance therefrom. A cap is removably engageable with the at least one spout. During use of the apparatus, upon external manual pressure being applied to the first compartment or second compartment, the frangible seal separates cleanly and uniformly along a length of the frangible seal, turning the first compartment and second compartment back into the single pouch cavity, and causing the first substance to mix with the second substance, without introducing extraneous materials or residues into the pouch cavity.

In at least one embodiment, a method for manufacturing and filling the multi-compartment pouch apparatus comprises the steps of—with the spout already engaged with the pouch portion, the cap already engaged with the spout, and the frangible seal already dividing the pouch cavity into the first compartment and separate second compartment within the pouch portion—positioning the apparatus in a dehumidified environment; temporarily inserting a first dispensing nozzle into the perimeter edge of the pouch portion so as to be in fluid communication with the first compartment; flushing the first compartment with a volume of nitrogen gas via the first dispensing nozzle so as to purge the first compartment of oxygen and moisture; with oxygen and moisture displaced from the first compartment, introducing a predetermined volume of the powdered infant formula into the first compartment via the first dispensing nozzle; flushing the first compartment again with a volume of nitrogen gas via the first dispensing nozzle so as to purge the first compartment of oxygen and moisture; retracting the first dispensing nozzle from the perimeter edge of the pouch portion; sealing the perimeter edge of the pouch portion proximal to the first compartment so as to create a permanent seal between the first sheet and second sheet of laminate material; temporarily inserting a second dispensing nozzle into the perimeter edge of the pouch portion so as to be in fluid communication with the second compartment; flushing the second compartment with a volume of nitrogen gas via the second dispensing nozzle so as to purge the second compartment of oxygen and moisture; with oxygen and moisture displaced from the second compartment, introducing a predetermined volume of water into the second compartment via the second dispensing nozzle; flushing the second compartment again with a volume of nitrogen gas via the second dispensing nozzle so as to purge the second compartment of oxygen; retracting the second dispensing nozzle from the perimeter edge of the pouch portion; sealing the perimeter edge of the pouch portion proximal to the second compartment so as to create a permanent seal between the first sheet and second sheet of laminate material; sterilizing an outer surface of the pouch portion; inserting the pouch portion into the storage sleeve; flushing the storage sleeve with a volume of nitrogen gas so as to purge the storage sleeve of oxygen and moisture; and sealing the storage sleeve.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIG. 1 is a perspective view of an exemplary multi-compartment pouch apparatus in a flattened, unfilled state, in accordance with at least one embodiment;

FIG. 2 is a side elevational view thereof, in accordance with at least one embodiment;

FIG. 3 is an exploded view of the layers of a pouch portion of the apparatus, in accordance with at least one embodiment;

FIG. 4 is a side elevational view of the pouch portion partially positioned within an exemplary storage sleeve of the apparatus, in accordance with at least one embodiment;

FIG. 5 is an exploded view of a spout assembly of the apparatus, in accordance with at least one embodiment;

FIG. 6 is an exploded view of the partially assembled spout assembly, in accordance with at least one embodiment;

FIG. 7 is a partial side elevational view of the pouch portion, with a side wall of the pouch portion omitted for illustrative purposes, in accordance with at least one embodiment; and

FIG. 8 is a flow diagram of an exemplary method for manufacturing and filling the apparatus, in accordance with at least one embodiment.

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments.

### DETAILED DESCRIPTION

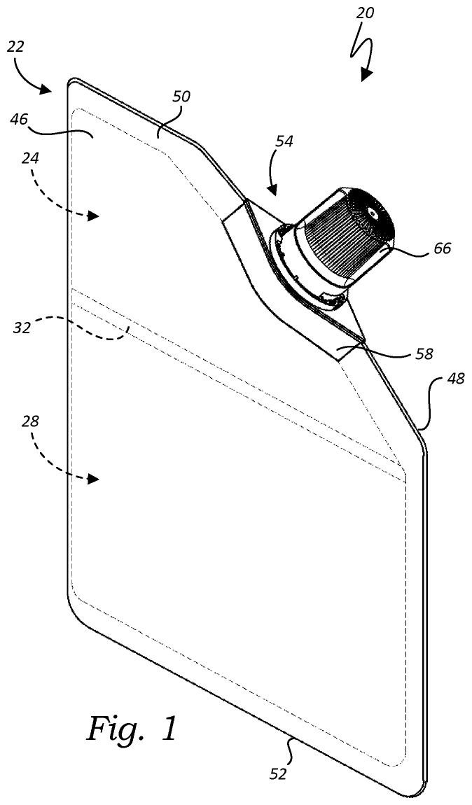

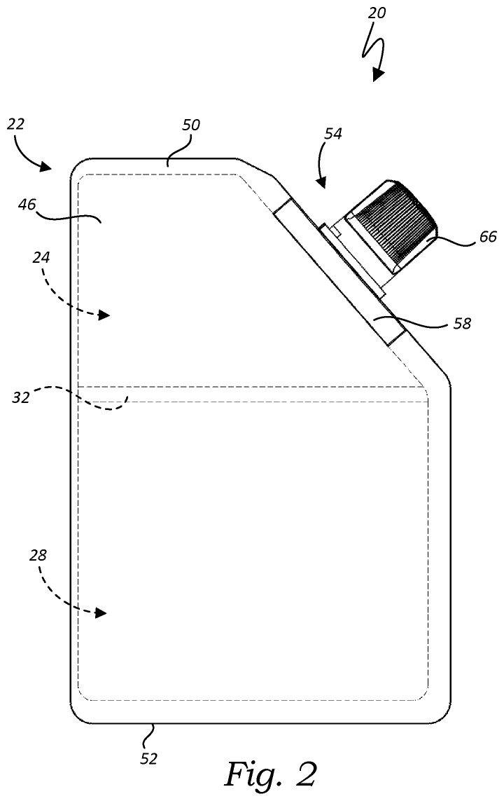

Turning now to FIGS. 1 and 2, there is shown an exemplary multi-compartment pouch apparatus 20, in accordance with at least one embodiment. In at least one embodiment, the apparatus 20 provides a pouch portion 22 defining therewithin a first compartment 24 containing a first substance 26 (which, in at least one embodiment, could be a combination of two or more substances), and a separate second compartment 28 containing a second substance 30 (which, in at least one embodiment, could be a combination of two or more substances), with a frangible seal 32 separating the first compartment 24 and the second compartment 28, as discussed further below. At the outset, it should be noted that while the apparatus 20 is herein discussed primarily in the context of infant formula for illustrative purposes, the apparatus 20 should not be read as being so limited. In further embodiments, the apparatus 20 may be configured for containing any other types of substances, now known or later developed, where there is a need for keeping two or more substances separated until said substances are ready to be mixed and used. Additionally, the embodiment of the apparatus 20 depicted in the drawings is merely exemplary and shown for illustrative purposes. As such, in further embodiments, the apparatus 20 (along with each of the components of the apparatus 20 described herein) may take on any other sizes, shapes, dimensions and/or configurations, now known or later developed—dependent at least in part on the context in which the apparatus 20 is to be used—so long as the apparatus 20 is capable of substantially carrying out the functionality described herein.

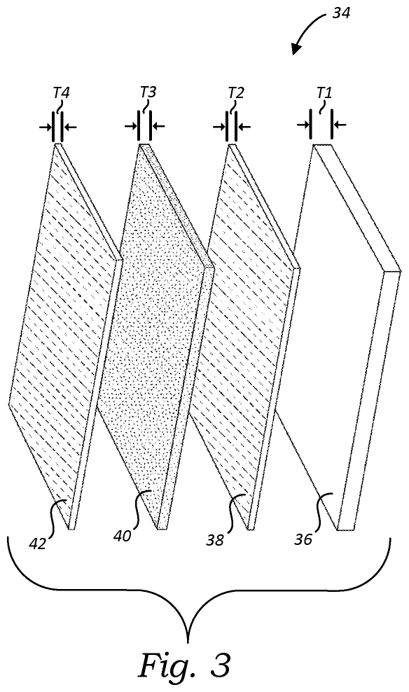

In at least one embodiment, the pouch portion 22 is constructed out of a substantially flat, flexible laminate material 34 comprising a plurality of layers. In at least one embodiment, as best illustrated in FIG. 3, an innermost layer 36 of the laminate material 34 is constructed out of a polyethylene (“PE”) material configured for being heat-sealable, biocompatible for food contact, and providing a compliant interface that is capable of being welded reproducibly. Polyethylene is capable of being sealed at temperatures below the softening point of polyethylene terephthalate (“PET”) and below the onset of thermal distortion of nylon. This enables creation of both structural perimeter seals and the internal calibrated frangible seal 32 without damaging other layers of the laminate material 34. In at least one embodiment, the innermost layer 36 has a thickness T1 of approximately 0.035-0.105 millimeters (preferably, 0.070 millimeters in at least one embodiment). However, in at least one alternate embodiment, the innermost layer 36 may have a thickness T1 of less than 0.035 millimeters or greater than 0.105 millimeters—dependent at least in part on the context in which the apparatus 20 is to be used—so long as the apparatus 20 is capable of substantially carrying out the functionality described herein. In at least one alternate embodiment, the innermost layer 36 may be constructed out of any other material (or combination of materials), now known or later developed, capable of being heat-sealable, biocompatible for food contact, and providing a compliant interface that is capable of being welded reproducibly—dependent at least in part on the context in which the apparatus 20 is to be used—so long as the apparatus 20 is capable of substantially carrying out the functionality described herein.

In at least one embodiment, a second layer 38, adjacent to the innermost layer 36, is constructed out of a polyamide (“PA”) material (such as nylon, for example) configured for providing puncture resistance, tear resistance, and flexural toughness to the laminate material 34. In at least one embodiment, the polyamide material absorbs and redistributes localized strain, preventing microcrack and pinhole formation in the laminate material 34 during repeated handling, drop events, and, importantly, manual squeezing at the point of use, as discussed further below. The polyamide material also mitigates stress concentration where powder particles (abrasive solids) might contact the innermost layer 36 in one or both of the first compartment 24 and second compartment 28, and where hydrostatic load from liquid acts in the other of the first compartment 24 and second compartment 28. This balanced toughness is highly beneficial in use cases where the apparatus 20 must survive both storage and deliberate deformation (the squeeze-to-mix step discussed below) without failure of the laminate material 34. In at least one embodiment, the second layer 38 has a thickness T2 of approximately 0.0075-0.0225 millimeters (preferably, 0.015 millimeters in at least one embodiment). However, in at least one alternate embodiment, the second layer 38 may have a thickness T2 of less than 0.0075 millimeters or greater than 0.0225 millimeters—dependent at least in part on the context in which the apparatus 20 is to be used—so long as the apparatus 20 is capable of substantially carrying out the functionality described herein. In at least one alternate embodiment, the second layer 38 may be constructed out of any other material (or combination of materials), now known or later developed, capable of providing puncture resistance, tear resistance, and flexural toughness to the laminate material 34—dependent at least in part on the context in which the apparatus 20 is to be used—so long as the apparatus 20 is capable of substantially carrying out the functionality described herein.

In at least one embodiment, a third layer 40, adjacent to the second layer 38, is constructed out of an aluminum foil (“AL”) material configured for providing an oxygen barrier and light barrier to the laminate material 34. Aluminum foil is effectively an oxygen and light barrier, with near-zero oxygen transmission rate (“OTR”) and excellent UV/visible light attenuation. In embodiments where the apparatus 20 is utilized to contain infant formula, infant formula often contains oxidation-sensitive lipids (e.g., DHA, ARA) and vitamins, such that exposure to oxygen and light accelerates degradation, off-flavor, and nutritional loss during storage. However, unsupported aluminum foil by itself is brittle and prone to pinhole formation under flexural stress, which is why the second layer 38 is constructed out of a polyamide material, so as to mechanically support the aluminum foil material of the third layer 40. In at least one embodiment, the third layer 40 has a thickness T3 of approximately 0.0035-0.0105 millimeters (preferably, 0.007 millimeters in at least one embodiment). However, in at least one alternate embodiment, the third layer 40 may have a thickness T3 of less than 0.0035 millimeters or greater than 0.0105 millimeters—dependent at least in part on the context in which the apparatus 20 is to be used—so long as the apparatus 20 is capable of substantially carrying out the functionality described herein. In at least one alternate embodiment, the third layer 40 may be constructed out of any other material (or combination of materials), now known or later developed, capable of providing an oxygen barrier and light barrier to the laminate material 34—dependent at least in part on the context in which the apparatus 20 is to be used—so long as the apparatus 20 is capable of substantially carrying out the functionality described herein.

In at least one embodiment, an outermost layer 42, adjacent to the third layer 40, is constructed out of a polyethylene terephthalate (“PET”) material configured for providing tensile strength, dimensional stability under heat, and resistance to creep to the laminate material 34, which helps the apparatus 20 maintain structural form during heat sealing, nitrogen flushing, transport, and user handling. The polyethylene terephthalate material also serves as a printable and scuff-resistant surface for the outermost layer 42 of the laminate material 34. Polyethylene terephthalate's relatively high modulus also prevents ballooning or uncontrolled deformation under hydrostatic loading in embodiments where one or both of the first compartment 24 and second compartment 28 contains a liquid. In at least one embodiment, the outermost layer 42 has a thickness T4 of approximately 0.006-0.018 millimeters (preferably, 0.012 millimeters in at least one embodiment). However, in at least one alternate embodiment, the outermost layer 42 may have a thickness T4 of less than 0.006 millimeters or greater than 0.018 millimeters—dependent at least in part on the context in which the apparatus 20 is to be used—so long as the apparatus 20 is capable of substantially carrying out the functionality described herein. In at least one alternate embodiment, the outermost layer 42 may be constructed out of any other material (or combination of materials), now known or later developed, capable of providing tensile strength, dimensional stability under heat, and resistance to creep to the laminate material 34—dependent at least in part on the context in which the apparatus 20 is to be used—so long as the apparatus 20 is capable of substantially carrying out the functionality described herein.

Accordingly, in at least one embodiment, the pouch portion 22 is constructed out of a mechanically reinforced, high-barrier laminate with controlled flexibility, capable of simultaneously achieving a very low oxygen transmission rate and moisture vapor transmission (by virtue of the second layer 38, third layer 40, and outermost layer 42 in combination), resistance to puncture and crack propagation under point loading and squeeze activation (by virtue of the second layer 38), and reliable, sterile, food-safe sealing and frangible-behavior tuning (by virtue of the innermost layer 36). In at least one alternate embodiment, the order of the above-described layers of the laminate material 34 may vary—dependent at least in part on the context in which the apparatus 20 is to be used—so long as the apparatus 20 is capable of substantially carrying out the functionality described herein. Additionally, in at least one alternate embodiment, one or more of the above-described layers of the laminate material 34 may be omitted—dependent at least in part on the context in which the apparatus 20 is to be used—so long as the apparatus 20 is capable of substantially carrying out the functionality described herein.

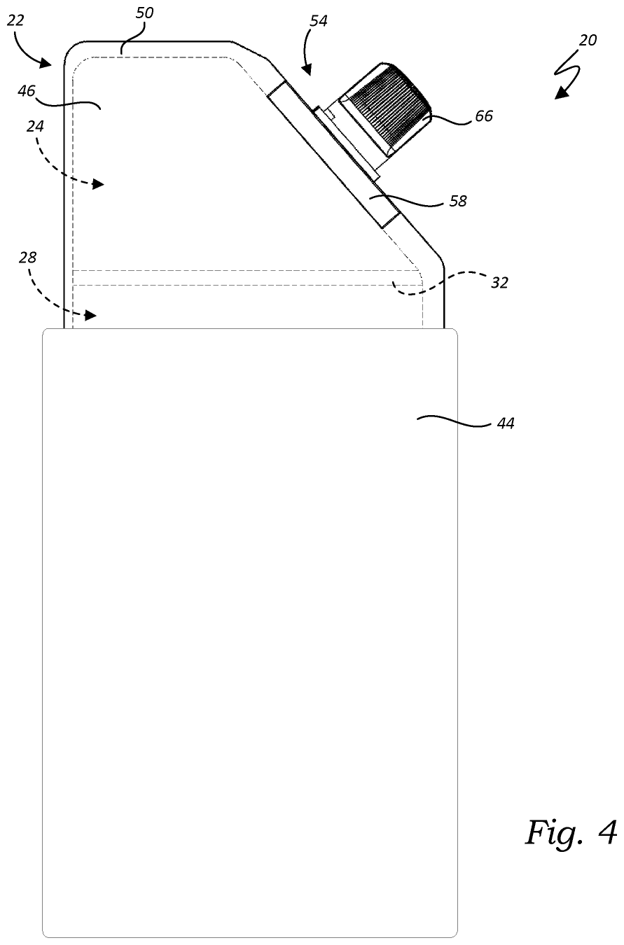

In at least one embodiment, the laminate material 34 of the pouch portion 22 is substantially transparent, thereby allowing the user to visually confirm the contents of the pouch portion 22 prior to use. In at least one embodiment, as best illustrated in FIG. 4, the apparatus 20 further provides an at least one storage sleeve 44 within which the pouch portion 22 is temporarily positioned during storage and transport (i.e., prior to use). In at least one such embodiment, the storage sleeve 44 is constructed out of a substantially opaque material configured for blocking light (such as an aluminum-based material, for example) so as to better protect the contents of the pouch portion 22 prior to use. In embodiments where the apparatus 20 is utilized to contain infant formula, infant formula ingredients, such as polyunsaturated fatty acids, certain vitamins, and probiotic components, are light-sensitive and undergo photodegradation and oxidation when exposed to light and oxygen during storage. However, fully opaque packaging, while providing excellent protection from light and oxygen, prevents the user from visually inspecting the contents prior to use. Thus, the removable storage sleeve 44 provides both the necessary protection prior to use, while also allowing for visual inspection of the contents of the pouch portion 22, once the pouch portion 22 has been removed from the storage sleeve 44.

In at least one embodiment, as mentioned above, the pouch portion 22 defines therewithin a first compartment 24 containing a first substance 26, and a separate second compartment 28 containing a second substance 30, with a frangible seal 32 separating the first compartment 24 and the second compartment 28. In that regard, it should be noted that in further embodiments, the pouch portion 22 may define three or more compartments containing respective materials. Thus, in further embodiment, the compartments may take on any other sizes, shapes, dimensions, configurations, quantities and/or relative positions, now known or later developed—dependent at least in part on the context in which the apparatus 20 is to be used—so long as the apparatus 20 is capable of substantially carrying out the functionality described herein.

In at least one embodiment, the first compartment 24 and second compartment 28 are defined by a first sheet 46 of laminate material 34 and an opposing second sheet 48 of laminate material 34 secured to one another about a sealed perimeter edge 50—using sonic welding, heat welding, adhesive, or any other material or technique, now known or later developed, capable of creating a permanent seal between the first sheet 46 and second sheet 48 of laminate material 34—with a pouch cavity between the first and second sheets 46 and 48 of the laminate material 34 divided into the first compartment 24 and second compartment 28 via the frangible seal 32. In at least one embodiment, the pouch portion 22 further provides a bottom sheet of laminate material 34 (not shown) spanning a bottom perimeter edge 52 of each of the first sheet 46 and second sheet 48 of laminate material 34 so as to form a gusset configured for both increasing the volume of one or both of the first compartment 24 and second compartment 28, as well as providing a stable base on which the pouch portion 22 may be oriented in a substantially upright or vertical position when placed on a substantially horizontal surface.

In at least one embodiment, the frangible seal 32 is formed as a heat seal between the innermost layer 36 of each of the first and second sheets 46 and 48 of the laminate material 34, without use of any adhesive materials. In at least one such embodiment, the frangible seal 32 is formed by controlled heat sealing of the innermost layer 36 of each of the first and second sheets 46 and 48 of the laminate material 34 under tightly controlled temperature, dwell time, and seal width. From a sealing science standpoint, predictable frangible performance requires that the interfacial bond between the innermost layer 36 of each of the sheets 46 and 48 of the laminate material 34 is structurally weaker than the cohesive strength of each innermost layer 36 itself and the strength of the sealed perimeter edge 50. The frangible seal 32 is configured such that, under a defined internal pressure (generated when the user squeezes the pouch portion 22), the frangible seal 32 separates cleanly and uniformly along its own interface rather than tearing, delaminating, or generating polymer fragments, adhesive debris, or delaminated particles that could enter the resulting pouch cavity. This level of tuning is technically challenging because small variations in seal temperature, seal dwell time, and film thickness dramatically affect burst pressure and failure mode in multilayer films. Importantly, in embodiments where one of the first substance 26 and second substance 30 is a solid (such as a powder, for example) and the other of the first substance 26 and second substance 30 is a liquid, the presence of both a liquid compartment and a solid compartment creates asymmetric loading: the liquid side can transmit hydrostatic pressure uniformly into the frangible seal 32, while the solid side can exert localized stress concentrations. Thus, in such embodiments, the frangible seal 32 is robust against that asymmetry pre-use, and yet reliably opens when intentionally actuated (through the pressure of the user manually squeezing the first compartment 24 or second compartment 28 of the pouch portion 22). The outcome is a frangible seal 32 that opens on-demand, under manual squeezing, turning the first compartment 24 and second compartment 28 back into the single pouch cavity, and causing the first substance 26 of the first compartment 24 to mix with the second substance 30 of the second compartment 28, without introducing extraneous materials or residues into the pouch cavity.

In at least one embodiment, the frangible seal 32 is configured to separate only under intentional manual compression of the first compartment 24 or second compartment 28 that exceeds a predefined threshold equivalent to being manually squeezed by a hand of the user, such that the frangible seal 32 resists unintentional separation from incidental pressure such as during packing or transport of the apparatus 20. Additionally, in at least one embodiment, the frangible seal 32 is configured for separating at any point along its length upon application of sufficient manual pressure. In at least one embodiment, the frangible seal 32 extends laterally across the pouch portion 22 so as to form the first compartment 24 and second compartment 28. However, in at least one alternate embodiment, the frangible seal 32 may extend longitudinally across the pouch portion 22. In at least one further alternate embodiment, the frangible seal 32 may extend along a substantially non-linear path across the pouch portion 22. In at least one embodiment, the first compartment 24 has a volume that is substantially equal to a volume of the second compartment 28. In at least one alternate embodiment, the first compartment 24 has a volume that is different than the volume of the second compartment 28.

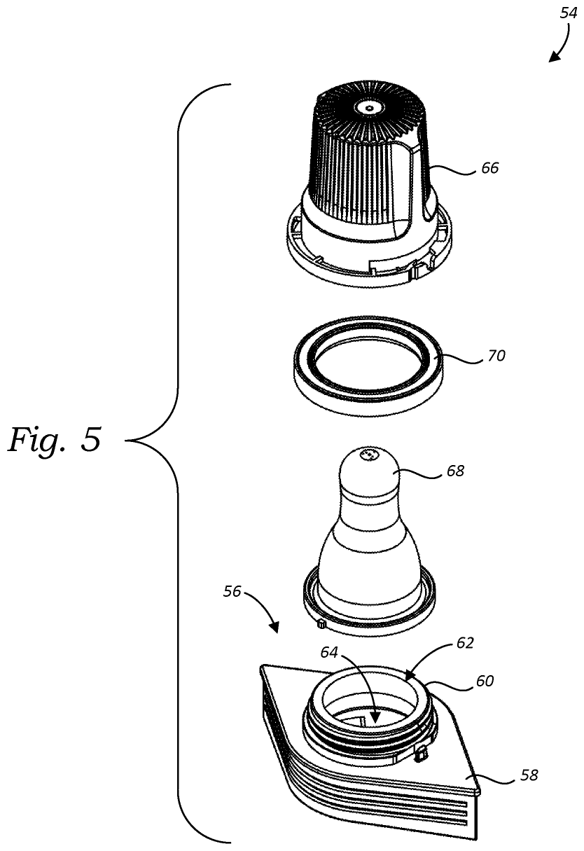

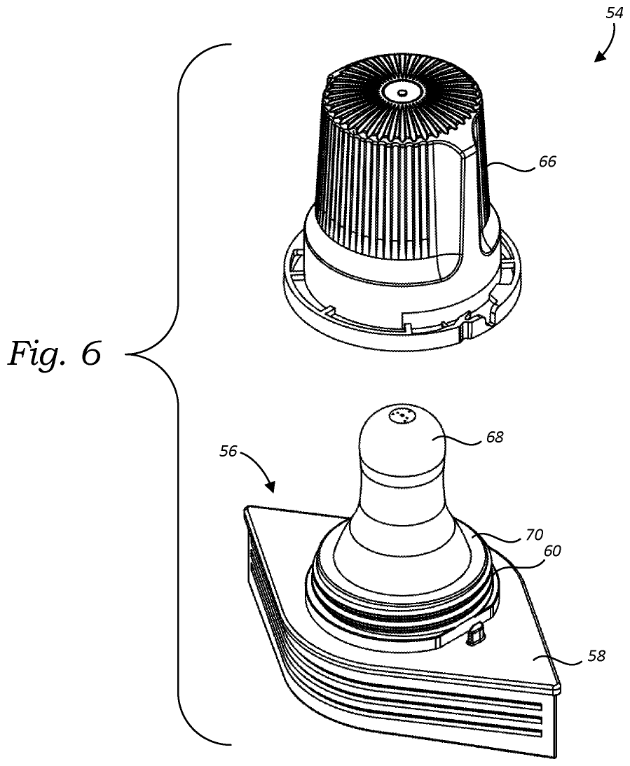

In at least one embodiment, the pouch portion 22 provides an at least one spout 54 in f luid communication with the pouch cavity for selectively dispensing the contents of the pouch cavity therefrom. In at least one embodiment, as illustrated in FIGS. 5 and 6, the spout 54 provides a spout connector 56 having a connector base 58 on which is positioned a substantially cylindrical-shaped mounting member 60 extending substantially perpendicularly from the connector base 58 and defining a spout aperture 62 therewithin. The spout aperture 62 is in fluid communication with a spout passageway 64 that extends through the spout connector 56. In at least one embodiment, the connector base 58 is used for connecting the spout connector 56 to the perimeter edge 50 of the pouch portion 22 (FIG. 1), such that the contents within the pouch cavity may exit the pouch cavity via the spout passageway 64 and the spout aperture 62. In at least one embodiment, the connector base 58 may be fixed to the perimeter edge 50 of the pouch portion 22 using many different methods—for example, sonic welding, heat welding or by using hot melt adhesive. In at least one embodiment, the connector base 58 is substantially elliptical in shape so as to provide the connector base 58 with an increased connecting surface for connecting the connector base 58 to the perimeter edge 50 of the pouch portion 22. However, in at least one alternate embodiment, the connector base 58 may take on any other sizes, shapes, dimensions and/or configurations, now known or later developed, so long as the connector base 58 is capable of being fixed to the perimeter edge 50 of the pouch portion 22.

In at least one embodiment, the at least one spout 54 further provides a cap 66 that is removably engageable with the mounting member 60 for selectively obstructing the spout aperture 62 and preventing the contents of the pouch cavity from exiting therethrough. In at least one embodiment, the cap 66 is threadably engageable with the mounting member 60. In at least one such embodiment, the cap 66 is a tamper-evident cap 66 that includes a visible indicator when the cap 66 has been removed or compromised. In at least one alternate embodiment, the cap 66 may be removably engageable with the mounting member 60 using any other mechanism or technique, now known or later developed, capable of creating a removable engagement between the cap 66 and the mounting member 60.

In at least one embodiment, the at least one spout 54 further provides a nipple 68 engaged with the mounting member 60. In at least one embodiment, the nipple 68 is constructed out of a food-grade silicone material, which is a safe, durable and hygienic material for baby bottle nipples. In at least one alternate embodiment, the nipple 68 is constructed out of rubber, synthetic latex, or any other material (or combination of materials), now known or later developed, capable of being safe, durable and hygienic. In at least one such embodiment, the nipple 68 is fit over the mounting member 60 and, under the application of heat thereto, material from the nipple 68 melts and subsequently sets into the mounting member 60. In at least one alternate embodiment, the nipple 68 is engaged with the mounting member 60 via an annular retaining ring 70 configured for engagement with the mounting member 60 so as to capture and sandwich the nipple 68 therebetween. In at least one such embodiment, the retaining ring 70 is threadably engageable with the mounting member 60. In further alternate embodiments, the nipple 68 may be engaged with the mounting member 60 using any other mechanism or technique, now known or later developed, capable of creating an engagement (removable or permanent) between the nipple 68 and the mounting member 60. In at least one embodiment, the nipple 68 is permanently engaged with the mounting member 60 during manufacture of the apparatus 20, such that the user is not required to install the nipple 68 themselves during use. Additionally, in such embodiments, the cap 66 covers the spout 54 and nipple 68, keeping the spout 54 and nipple 68 sterile until use.

In at least one alternate embodiment, the spout 54 may take on any other sizes, shapes, dimensions and/or configurations, now known or later developed—dependent at least in part on the context in which the apparatus 20 is to be used—so long as the apparatus 20 is capable of substantially carrying out the functionality described herein. Additionally, in at least one alternate embodiment, the spout 54 may be positioned and engaged anywhere else on the pouch portion 22—dependent at least in part on the context in which the apparatus 20 is to be used—so long as the apparatus 20 is capable of substantially carrying out the functionality described herein.

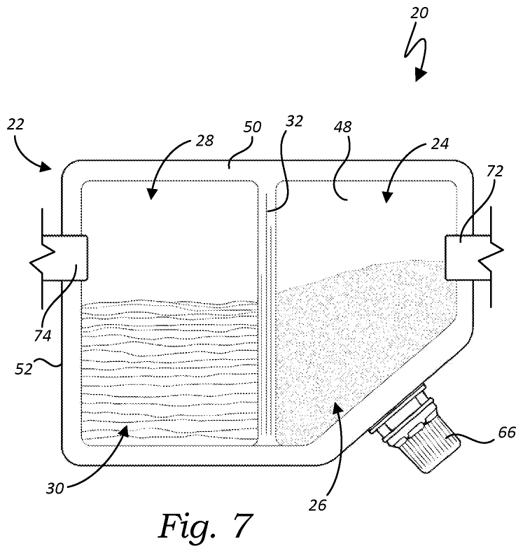

In at least one embodiment, the apparatus 20 is configured for storing and subsequently dispensing infant formula. In at least one such embodiment, the apparatus 20 is configured for use as a single-use infant formula pouch engineered to combine dry formula and a liquid within a sealed, flexible package that is ready for immediate use. Thus, in at least one such embodiment, as illustrated in FIG. 7, the first substance 26 positioned within the first compartment 24 is a dry formula in solid form (such as a powder, for example), while the second substance 30 positioned within the second compartment 28 is a liquid (such as purified, deionized water, for example).

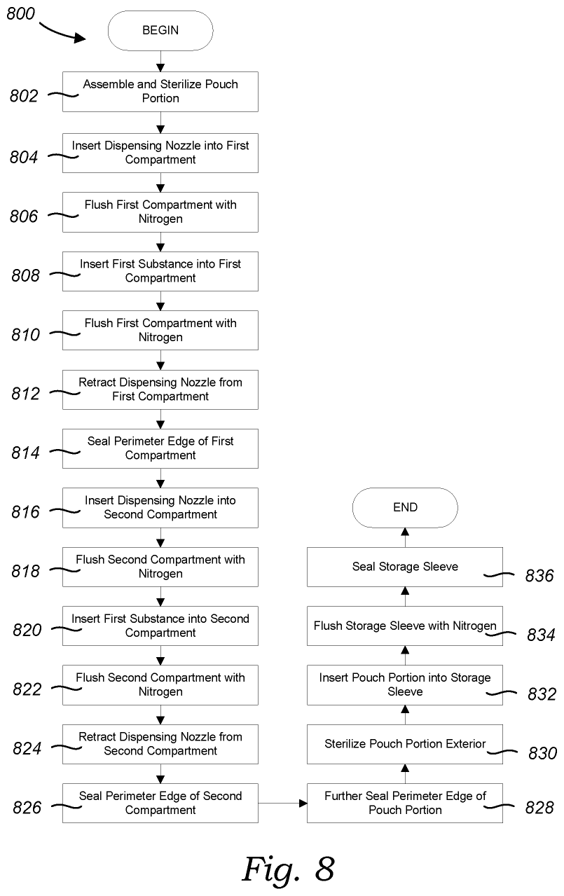

In at least one embodiment, as illustrated in the flow diagram of FIG. 8, the apparatus 20 is manufactured using an automated process that includes separate or multi-stage filling and sealing for the first compartment 24 and second compartment 28, with separate dispensing nozzles 72 and 74 (FIG. 7) at a shared or different stations on the manufacturing equipment, with the manufacturing equipment located in an environment having dehumidified conditions so as to better prevent microbial growth and contamination. In at least one embodiment, with the pouch portion 22 fully assembled—including the spout 54 engaged with the pouch portion 22, the tamper-evident cap 66 engaged with the spout 54, and the frangible seal 32 forming the first compartment 24 and second compartment 28 within the pouch portion 22—and pre-sterilized (802), a first dispensing nozzle 72 is temporarily inserted into the perimeter edge 50 of the pouch portion 22 so as to be in fluid communication with the first compartment 24 (804). The first compartment 24 is then flushed with a volume of nitrogen gas via the first dispensing nozzle 72 so as to purge the first compartment 24 of oxygen and moisture (806). With oxygen and moisture displaced from the first compartment 24, a predetermined volume of the first substance 26 (such as powdered formula, in at least one embodiment) is then introduced into the first compartment 24 via the first dispensing nozzle 72 (808). The first compartment 24 is then flushed once more with a volume of nitrogen gas via the first dispensing nozzle 72 so as to purge the first compartment 24 of oxygen (810). The first dispensing nozzle 72 is then retracted from the perimeter edge 50 of the pouch portion 22 (812), and the perimeter edge 50 proximal the first compartment 24 is sealed using sonic welding, heat welding, adhesive, or any other material or technique, now known or later developed, capable of creating a permanent seal between the first sheet 46 and second sheet 48 of laminate material 34 (814). Because the first compartment 24 is flushed with nitrogen gas prior to the perimeter edge 50 of the pouch portion 22 being sealed, the interior environment within the first compartment 24 is substantially free of oxygen and air, thereby better preventing oxidation and microbial contamination of the first substance 26 and prolonging the shelf life of the apparatus 20. In at least one embodiment, the predetermined volume of the first substance 26 within the first compartment 24 is about 25%-50% of the total volume of the first compartment 24, with the remaining volume of the first compartment 24 being filled with a mixture of nitrogen gas and air. However, in at least one alternate embodiment, the predetermined volume of the first substance 26 within the first compartment 24 may be less than 25% or greater than 50% of the total volume of the first compartment 24—dependent at least in part on first substance 26 and the context in which the apparatus 20 is to be used—so long as the apparatus 20 is capable of substantially carrying out the functionality described herein.

In at least one embodiment, a second dispensing nozzle 74 is temporarily inserted into the perimeter edge 50 of the pouch portion 22 so as to be in fluid communication with the second compartment 28 (816). The second compartment 28 is then flushed with a volume of nitrogen gas via the second dispensing nozzle 74 so as to purge the second compartment 28 of oxygen and moisture (818). With oxygen and moisture displaced from the second compartment 28, a predetermined volume of the second substance 30 (such as purified, deionized, UV-treated, temperature-controlled water, in at least one embodiment) is then introduced into the second compartment 28 via the second dispensing nozzle 74 (820). The second compartment 28 is then flushed once more with a volume of nitrogen gas via the second dispensing nozzle 74 so as to purge the second compartment 28 of oxygen (822). The second dispensing nozzle 74 is then retracted from the perimeter edge 50 of the pouch portion 22 (824), and the perimeter edge 50 proximal the second compartment 28 is sealed using sonic welding, heat welding, adhesive, or any other material or technique, now known or later developed, capable of creating a permanent seal between the first sheet 46 and second sheet 48 of laminate material 34 (826). Because the second compartment 28 is flushed with nitrogen gas prior to the perimeter edge 50 of the pouch portion 22 being sealed, the interior environment within the second compartment 28 is substantially free of oxygen and air, thereby better preventing oxidation and microbial contamination of the second substance 30 and prolonging the shelf life of the apparatus 20. In at least one embodiment, the predetermined volume of the second substance 30 within the second compartment 28 is about 25%-50% of the total volume of the second compartment 28, with the remaining volume of the second compartment 28 being filled with a mixture of nitrogen gas and air. However, in at least one alternate embodiment, the predetermined volume of the second substance 30 within the second compartment 28 may be less than 25% or greater than 50% of the total volume of the second compartment 28—dependent at least in part on second substance 30 and the context in which the apparatus 20 is to be used—so long as the apparatus 20 is capable of substantially carrying out the functionality described herein. In at least one embodiment, during steps (804)-(826), the pouch portion 22 is held by the manufacturing equipment is a substantially horizontal orientation, as illustrated in FIG. 7, thereby providing access to both the first compartment 24 and the second compartment 28 during the filling process.

In at least one embodiment, with both the first compartment 24 and second compartment 28 now filled with the respective first substance 26 and second substance 30 and subsequently sealed, the perimeter edge 50 of the pouch portion 22 is once more heat sealed to better ensure a leak-proof integrity along the entire perimeter edge 50 (828). In at least one embodiment, an outer surface of the pouch portion 22 is sterilized using one or both of UV light exposure and an antimicrobial spray (830), thereby better ensuring external sanitation of the pouch portion 22 before boxing and transport. In at least one embodiment, where one or both of the first sheet 46 and second sheet 48 of laminate material 34 is substantially transparent, the pouch portion 22 is inserted into the substantially opaque storage sleeve 44 (832). The storage sleeve 44 is then flushed with a volume of nitrogen gas so as to purge the storage sleeve 44 of oxygen and moisture (834), and the storage sleeve 44 is subsequently sealed (836). Thus, in at least one embodiment, the apparatus 20 is fully sanitary and sterile upon final sealing and eliminates cross-contamination risk by pre-filling all ingredients without human involvement.

In at least one embodiment, during subsequent use of the apparatus 20, the user (i.e., the caregiver who will subsequently feed the contents of the apparatus 20 to an infant) removes pouch portion 22 from the substantially opaque storage sleeve 44, which allows the user to visually inspect the first substance 26 and second substance 30 through the substantially transparent pouch portion 22 to determine whether there has been any contamination or spoilage with respect to the first substance 26 and second substance 30, in order to ensure that the contents of the pouch portion 22 are safe for consumption by the infant. The user then manually applies pressure to the first compartment 24 or second compartment 28 in order to rupture the frangible seal 32 therebetween, thereby allowing the first substance 26 and second substance 30 to mix into a consumable infant formula within the now formed pouch cavity. The user may shake the pouch portion 22 to further mix the first substance 26 and second substance 30 together prior to consumption. The cap 66 is then removed. In embodiments where the pouch portion 22 provides a nipple 68, the user may feed the infant directly from the nipple 68 of the pouch portion 22. Alternatively, in embodiments where the pouch portion 22 simply provides a spout 54, the user may pour the contents of the pouch cavity from the spout 54 into a bottle or other container for subsequent feeding of the infant.

Thus, in at least one embodiment, the apparatus 20 is a sterilized, tamper-evident, all-in-one, ready-to-feed, disposable, single-use container ideal for travel, night feedings, and emergency scenarios, requiring no additional components or assembly. In at least one embodiment, the apparatus 20 also resolves a long-standing tradeoff between visibility (i.e., user's desiring to visually inspect what the infant will ingest prior to feeding) and protection (i.e., the contents needing to remain chemically and nutritionally stable for many months)—all without exposing the contents to air or requiring transfer to a separate vessel.

Aspects of the present specification may also be described as the following embodiments:
1. A multi-compartment pouch apparatus comprising: a pouch portion constructed out of a first sheet and an opposing second sheet of a substantially flat, flexible laminate material secured to one another about a sealed perimeter edge thereof, the first sheet and second sheet of laminate material cooperating to define a pouch cavity therebetween; the laminate material comprising: an innermost layer constructed out of a polyethylene material configured for being heat-sealable, biocompatible for food contact, and providing a compliant interface that is capable of being welded reproducibly; a second layer, adjacent to the innermost layer, constructed out of a polyamide material configured for providing puncture resistance, tear resistance, and flexural toughness to the laminate material; a third layer, adjacent to the second layer, constructed out of an aluminum foil material configured for providing an oxygen barrier and light barrier to the laminate material; and an outermost layer, adjacent to the third layer, constructed out of a polyethylene terephthalate material configured for providing tensile strength, dimensional stability under heat, and resistance to creep to the laminate material; a frangible seal spanning the perimeter edge of the first sheet and second sheet of laminate material so as to divide the pouch cavity into a first compartment and a separate second compartment, the frangible seal formed as a heat seal between the innermost layer of each of the first sheet and second sheet of laminate material, without use of any adhesive materials, such that an interfacial bond between the innermost layer of each of the first sheet and second sheet of laminate material is structurally weaker than a cohesive strength of each innermost layer and of the sealed perimeter edge; the first compartment containing a volume of a first substance; the second compartment containing a volume of a second substance; an at least one spout in fluid communication with the pouch cavity for selectively dispensing the first substance and second substance therefrom; and a cap removably engageable with the at least one spout; whereby, during use of the apparatus, upon external manual pressure being applied to the first compartment or second compartment, the frangible seal separates cleanly and uniformly along a length of the frangible seal, turning the first compartment and second compartment back into the single pouch cavity, and causing the first substance to mix with the second substance, without introducing extraneous materials or residues into the pouch cavity.
2. The apparatus according to embodiment 1, wherein the perimeter edge of the pouch portion is sealed using one of sonic welding, heat welding and adhesive.
3. The apparatus according to embodiments 1-2, wherein the pouch portion further provides a bottom sheet of laminate material spanning a bottom perimeter edge of each of the first sheet and second sheet of laminate material so as to form a gusset configured for both increasing the volume of one or both of the first compartment and second compartment, as well as providing a stable base on which the pouch portion may be oriented in a substantially upright or vertical position when placed on a substantially horizontal surface.
4. The apparatus according to embodiments 1-3, wherein the laminate material of the pouch portion is substantially transparent, thereby allowing for visual inspection of the first substance and second substance through the laminate material.
5. The apparatus according to embodiments 1-4, further comprising an at least one storage sleeve within which the pouch portion is temporarily positioned during storage and transport, the at least one storage sleeve constructed out of a substantially opaque material configured for blocking light.
6. The apparatus according to embodiments 1-5, wherein: the first substance is a solid; and the second substance is a liquid.
7. The apparatus according to embodiments 1-6, wherein: the first substance is a powdered infant formula; and the second substance is water.
8. The apparatus according to embodiments 1-7, wherein the frangible seal is configured to separate only under intentional external manual compression of the first compartment or second compartment that exceeds a predefined threshold equivalent to being manually squeezed by a hand of a user, such that the frangible seal resists unintentional separation from incidental pressure such as during packing or transport of the apparatus.
9. The apparatus according to embodiments 1-8, wherein the frangible seal extends laterally across the pouch portion.
10. The apparatus according to embodiments 1-9, wherein the frangible seal extends longitudinally across the pouch portion.
11. The apparatus according to embodiments 1-10, wherein the frangible seal extends along a substantially non-linear path across the pouch portion.
12. The apparatus according to embodiments 1-11, wherein the first compartment has a volume that is substantially the same as a volume of the second compartment.
13. The apparatus according to embodiments 1-12, wherein the first compartment has a volume that is different than a volume of the second compartment.
14. The apparatus according to embodiments 1-13, wherein: the spout provides a spout connector having a connector base on which is positioned a substantially cylindrical-shaped mounting member extending substantially perpendicularly from the connector base and defining a spout aperture therewithin; the connector base is engaged with the pouch portion; and the spout aperture is in fluid communication with a spout passageway that extends through the spout connector and into the pouch cavity.
15. The apparatus according to embodiments 1-14, wherein the connector base is engaged with the perimeter edge of the pouch portion.
16. The apparatus according to embodiments 1-15, wherein the cap is removably engageable with the mounting member.
17. The apparatus according to embodiments 1-16, wherein the cap is threadably engageable with the mounting member.
18. The apparatus according to embodiments 1-17, wherein the cap is a tamper-evident cap that includes a visible indicator when the cap has been removed or compromised.
19. The apparatus according to embodiments 1-18, wherein the spout further provides a nipple.
20. The apparatus according to embodiments 1-19, wherein the nipple is engaged with the mounting member via an annular retaining ring configured for engagement with the mounting member so as to capture and sandwich the nipple therebetween.
21. The apparatus according to embodiments 1-20, wherein the retaining ring is threadably engageable with the mounting member.
22. The apparatus according to embodiments 1-21, wherein: the first compartment further contains a volume of nitrogen gas, such that the volume of the first substance is equal to about 25% to 50% of a total volume of the first compartment, with a remaining volume of the first compartment being filled with a mixture of nitrogen gas and air; and the second compartment further contains a volume of nitrogen gas, such that the volume of the second substance is equal to about 25% to 50% of a total volume of the second compartment, with a remaining volume of the second compartment being filled with a mixture of nitrogen gas and air.
23. The apparatus according to embodiments 1-22, wherein the innermost layer has a thickness of approximately 0.035-0.105 millimeters.
24. The apparatus according to embodiments 1-23, wherein the innermost layer has a thickness of less than 0.035 millimeters or greater than 0.105 millimeters.
25. The apparatus according to embodiments 1-24, wherein the innermost layer has a thickness of approximately 0.070 millimeters.
26. The apparatus according to embodiments 1-25, wherein the second layer has a thickness of approximately 0.0075-0.0225 millimeters.
27. The apparatus according to embodiments 1-26, wherein the second layer has a thickness of less than 0.0075 millimeters or greater than 0.0225 millimeters.
28. The apparatus according to embodiments 1-27, wherein the second layer has a thickness of approximately 0.015 millimeters.
29. The apparatus according to embodiments 1-28, wherein the third layer has a thickness of approximately 0.0035-0.0105 millimeters.
30. The apparatus according to embodiments 1-29, wherein the third layer has a thickness of less than 0.0035 millimeters or greater than 0.0105 millimeters.
31. The apparatus according to embodiments 1-30, wherein the third layer has a thickness of approximately 0.007 millimeters.
32. The apparatus according to embodiments 1-31, wherein the outermost layer has a thickness of approximately 0.006-0.018 millimeters.
33. The apparatus according to embodiments 1-32, wherein the outermost layer has a thickness of less than 0.006 millimeters or greater than 0.018 millimeters.
34. The apparatus according to embodiments 1-33, wherein the outermost layer has a thickness of approximately 0.012 millimeters.
35. A multi-compartment pouch apparatus comprising: a pouch portion constructed out of a first sheet and an opposing second sheet of a substantially flat, flexible laminate material secured to one another about a sealed perimeter edge thereof, the first sheet and second sheet of a substantially transparent laminate material cooperating to define a pouch cavity therebetween; the laminate material comprising: an innermost layer constructed out of a polyethylene material configured for being heat-sealable, biocompatible for food contact, and providing a compliant interface that is capable of being welded reproducibly; a second layer, adjacent to the innermost layer, constructed out of a polyamide material configured for providing puncture resistance, tear resistance, and flexural toughness to the laminate material; a third layer, adjacent to the second layer, constructed out of an aluminum foil material configured for providing an oxygen barrier and light barrier to the laminate material; and an outermost layer, adjacent to the third layer, constructed out of a polyethylene terephthalate material configured for providing tensile strength, dimensional stability under heat, and resistance to creep to the laminate material; a frangible seal spanning the perimeter edge of the first sheet and second sheet of laminate material so as to divide the pouch cavity into a first compartment and a separate second compartment, the frangible seal formed as a heat seal between the innermost layer of each of the first sheet and second sheet of laminate material, without use of any adhesive materials, such that an interfacial bond between the innermost layer of each of the first sheet and second sheet of laminate material is structurally weaker than a cohesive strength of each innermost layer and of the sealed perimeter edge; the first compartment containing a volume of a powdered infant formula along with a volume of nitrogen gas; the second compartment containing a volume of water along with a volume of nitrogen gas; a spout in fluid communication with the pouch cavity for selectively dispensing the powdered infant formula and water therefrom; a cap removably engageable with the spout; and a storage sleeve within which the pouch portion is temporarily positioned during storage and transport, the storage sleeve constructed out of a substantially opaque material configured for blocking light; whereby, during use of the apparatus, upon the pouch portion being removed from the storage sleeve and external manual pressure subsequently being applied to the first compartment or second compartment, the frangible seal separates cleanly and uniformly along a length of the frangible seal, turning the first compartment and second compartment back into the single pouch cavity, and causing the powdered infant formula to mix with the water prior to the cap being removed from the spout, without introducing extraneous materials or residues into the pouch cavity.
36. A method for manufacturing and filling the multi-compartment pouch apparatus according to embodiments 1-35 comprising the steps of, with the spout already engaged with the pouch portion, the cap already engaged with the spout, and the frangible seal already dividing the pouch cavity into the first compartment and separate second compartment within the pouch portion: positioning the apparatus in a dehumidified environment; temporarily inserting a first dispensing nozzle into the perimeter edge of the pouch portion so as to be in fluid communication with the first compartment; flushing the first compartment with a volume of nitrogen gas via the first dispensing nozzle so as to purge the first compartment of oxygen and moisture; with oxygen and moisture displaced from the first compartment, introducing a predetermined volume of the powdered infant formula into the first compartment via the first dispensing nozzle; flushing the first compartment again with a volume of nitrogen gas via the first dispensing nozzle so as to purge the first compartment of oxygen and moisture; retracting the first dispensing nozzle from the perimeter edge of the pouch portion; sealing the perimeter edge of the pouch portion proximal to the first compartment so as to create a permanent seal between the first sheet and second sheet of laminate material; temporarily inserting a second dispensing nozzle into the perimeter edge of the pouch portion so as to be in fluid communication with the second compartment; flushing the second compartment with a volume of nitrogen gas via the second dispensing nozzle so as to purge the second compartment of oxygen and moisture; with oxygen and moisture displaced from the second compartment, introducing a predetermined volume of water into the second compartment via the second dispensing nozzle; flushing the second compartment again with a volume of nitrogen gas via the second dispensing nozzle so as to purge the second compartment of oxygen; retracting the second dispensing nozzle from the perimeter edge of the pouch portion; sealing the perimeter edge of the pouch portion proximal to the second compartment so as to create a permanent seal between the first sheet and second sheet of laminate material; sterilizing an outer surface of the pouch portion; inserting the pouch portion into the storage sleeve; flushing the storage sleeve with a volume of nitrogen gas so as to purge the storage sleeve of oxygen and moisture; and sealing the storage sleeve.
37. The method according to embodiment 36, wherein: the step of introducing a predetermined volume of the powdered infant formula into the first compartment via the first dispensing nozzle further comprises the step of introducing a volume of powdered infant formula in an amount equal to about 25% to 50% of a total volume of the first compartment, with a remaining volume of the first compartment being filled with a mixture of nitrogen gas and air; and the step of introducing a predetermined volume of water into the second compartment via the second dispensing nozzle further comprises the step of introducing a volume of water in an amount equal to about 25% to 50% of a total volume of the second compartment, with a remaining volume of the second compartment being filled with a mixture of nitrogen gas and air.
38. The method according to embodiments 36-37, further comprising the step of, upon both the first compartment and second compartment being filled with the respective powdered infant formula and water, sealing the entire perimeter edge of the pouch portion once more to better ensure a leak-proof integrity along the entire perimeter edge.
39. The method according to embodiments 36-38, wherein the step of sterilizing an outer surface of the pouch portion further comprises the step of sterilizing the outer surface of the pouch portion using one or both of UV light exposure and an antimicrobial spray.

In closing, regarding the exemplary embodiments of the present invention as shown and described herein, it will be appreciated that a multi-compartment pouch apparatus along with associated methods of manufacture are disclosed and configured for configured for being a sterilized, tamper-evident, all-in-one, ready-to-feed, disposable, single-use container. Because the principles of the invention may be practiced in a number of configurations beyond those shown and described, it is to be understood that the invention is not in any way limited by the exemplary embodiments, but is generally directed to a multi-compartment pouch apparatus and is able to take numerous forms to do so without departing from the spirit and scope of the invention. It will also be appreciated by those skilled in the art that the present invention is not limited to the particular geometries and materials of construction disclosed, but may instead entail other functionally comparable structures or materials, now known or later developed, without departing from the spirit and scope of the invention.

Certain embodiments of the present invention are described herein, including the best mode known to the inventor(s) for carrying out the invention. Of course, variations on these described embodiments will become apparent to those of ordinary skill in the art upon reading the foregoing description. The inventor(s) expect skilled artisans to employ such variations as appropriate, and the inventor(s) intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the terms “about” and “approximately.” As used herein, the terms “about” and “approximately” mean that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein. Similarly, as used herein, unless indicated to the contrary, the term “substantially” is a term of degree intended to indicate an approximation of the characteristic, item, quantity, parameter, property, or term so qualified, encompassing a range that can be understood and construed by those of ordinary skill in the art, or at least encompassing a range of plus or minus ten percent above and below the value of the stated characteristic, item, quantity, parameter, property, or term.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a similar manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

The terms “a,” “an,” “the” and similar references used in the context of describing the present invention (especially in the context of the following claims) are to be construed to cover both the singular and the plural, unless otherwise indicated herein or clearly contradicted by context. Further, ordinal indicators-such as “first,” “second,” “third,” etc.-for identified elements are used to distinguish between the elements, and do not indicate or imply a required or limited number of such elements, and do not indicate a particular position or order of such elements unless otherwise specifically stated. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

When used in the claims, whether as filed or added per amendment, the open-ended transitional term “comprising” (along with equivalent open-ended transitional phrases thereof such as “including,” “containing” and “having”) encompasses all the expressly recited elements, limitations, steps and/or features alone or in combination with un-recited subject matter; the named elements, limitations and/or features are essential, but other unnamed elements, limitations and/or features may be added and still form a construct within the scope of the claim. Specific embodiments disclosed herein may be further limited in the claims using the closed-ended transitional phrases “consisting of” or “consisting essentially of” in lieu of or as an amendment for “comprising.” When used in the claims, whether as filed or added per amendment, the closed-ended transitional phrase “consisting of” excludes any element, limitation, step, or feature not expressly recited in the claims. The closed-ended transitional phrase “consisting essentially of” limits the scope of a claim to the expressly recited elements, limitations, steps and/or features and any other elements, limitations, steps and/or features that do not materially affect the basic and novel characteristic(s) of the claimed subject matter. Thus, the meaning of the open-ended transitional phrase “comprising” is being defined as encompassing all the specifically recited elements, limitations, steps and/or features as well as any optional, additional unspecified ones. The meaning of the closed-ended transitional phrase “consisting of” is being defined as only including those elements, limitations, steps and/or features specifically recited in the claim, whereas the meaning of the closed-ended transitional phrase “consisting essentially of” is being defined as only including those elements, limitations, steps and/or features specifically recited in the claim and those elements, limitations, steps and/or features that do not materially affect the basic and novel characteristic(s) of the claimed subject matter. Therefore, the open-ended transitional phrase “comprising” (along with equivalent open-ended transitional phrases thereof) includes within its meaning, as a limiting case, claimed subject matter specified by the closed-ended transitional phrases “consisting of” or “consisting essentially of.” As such, embodiments described herein or so claimed with the phrase “comprising” are expressly or inherently unambiguously described, enabled and supported herein for the phrases “consisting essentially of” and “consisting of.”

Any claims intended to be treated under 35 U.S.C. § 112(f) will begin with the words “means for,” but use of the term “for” in any other context is not intended to invoke treatment under 35 U.S.C. § 112(f). Accordingly, Applicant reserves the right to pursue additional claims after filing this application, in either this application or in a continuing application.

It should be understood that any methods disclosed herein, along with the order in which the respective elements of any such method are performed, are purely exemplary. Depending on the implementation, they may be performed in any order or in parallel, unless indicated otherwise in the present disclosure.

All patents, patent publications, and other publications referenced and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents are based on the information available to the applicants and does not constitute any admission as to the correctness of the dates or contents of these documents.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

All of the material in this patent document issue subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

What is claimed is:

1. A multi-compartment pouch apparatus comprising:
a pouch portion constructed out of a first sheet and an opposing second sheet of a substantially flat, flexible laminate material secured to one another about a sealed perimeter edge thereof, the first sheet and second sheet of laminate material cooperating to define a pouch cavity therebetween;
the laminate material comprising:
an innermost layer constructed out of a polyethylene material configured for being heat-sealable, biocompatible for food contact, and providing a compliant interface that is capable of being welded reproducibly;
a second layer, adjacent to the innermost layer, constructed out of a polyamide material configured for providing puncture resistance, tear resistance, and flexural toughness to the laminate material;
a third layer, adjacent to the second layer, constructed out of an aluminum foil material configured for providing an oxygen barrier and light barrier to the laminate material; and
an outermost layer, adjacent to the third layer, constructed out of a polyethylene terephthalate material configured for providing tensile strength, dimensional stability under heat, and resistance to creep to the laminate material;
a frangible seal spanning the perimeter edge of the first sheet and second sheet of laminate material so as to divide the pouch cavity into a first compartment and a separate second compartment, the frangible seal formed as a heat seal between the innermost layer of each of the first sheet and second sheet of laminate material, without use of any adhesive materials, such that an interfacial bond between the innermost layer of each of the first sheet and second sheet of laminate material is structurally weaker than a cohesive strength of each innermost layer and of the sealed perimeter edge;
the first compartment containing a volume of a first substance;
the second compartment containing a volume of a second substance;
an at least one spout in fluid communication with the pouch cavity for selectively dispensing the first substance and second substance therefrom; and
a cap removably engageable with the at least one spout;
whereby, during use of the apparatus, upon external manual pressure being applied to the first compartment or second compartment, the frangible seal separates cleanly and uniformly along a length of the frangible seal, turning the first compartment and second compartment back into the single pouch cavity, and causing the first substance to mix with the second substance, without introducing extraneous materials or residues into the pouch cavity.

2. The apparatus of claim 1, wherein the perimeter edge of the pouch portion is sealed using one of sonic welding, heat welding and adhesive.

3. The apparatus of claim 1, wherein the pouch portion further provides a bottom sheet of laminate material spanning a bottom perimeter edge of each of the first sheet and second sheet of laminate material so as to form a gusset configured for both increasing the volume of one or both of the first compartment and second compartment, as well as providing a stable base on which the pouch portion may be oriented in a substantially upright or vertical position when placed on a substantially horizontal surface.

4. The apparatus of claim 1, wherein the laminate material of the pouch portion is substantially transparent, thereby allowing for visual inspection of the first substance and second substance through the laminate material.

5. The apparatus of claim 4, further comprising an at least one storage sleeve within which the pouch portion is temporarily positioned during storage and transport, the at least one storage sleeve constructed out of a substantially opaque material configured for blocking light.

6. The apparatus of claim 1, wherein:
the first substance is a solid; and
the second substance is a liquid.

7. The apparatus of claim 6, wherein:
the first substance is a powdered infant formula; and
the second substance is water.

8. The apparatus of claim 1, wherein the frangible seal is configured to separate only under intentional external manual compression of the first compartment or second compartment that exceeds a predefined threshold equivalent to being manually squeezed by a hand of a user, such that the frangible seal resists unintentional separation from incidental pressure such as during packing or transport of the apparatus.

9. The apparatus of claim 1, wherein the cap is a tamper-evident cap that includes a visible indicator when the cap has been removed or compromised.

10. The apparatus of claim 1, wherein:
the spout provides a spout connector having a connector base on which is positioned a substantially cylindrical-shaped mounting member extending substantially perpendicularly from the connector base and defining a spout aperture therewithin;
the connector base is engaged with the pouch portion; and
the spout aperture is in fluid communication with a spout passageway that extends through the spout connector and into the pouch cavity.

11. The apparatus of claim 10, wherein the connector base is engaged with the perimeter edge of the pouch portion.

12. The apparatus of claim 10, wherein the cap is removably engageable with the mounting member.

13. The apparatus of claim 10, wherein the spout further provides a nipple.

14. The apparatus of claim 13, wherein the nipple is engaged with the mounting member via an annular retaining ring configured for engagement with the mounting member so as to capture and sandwich the nipple therebetween.

15. The apparatus of claim 1, wherein:
the first compartment further contains a volume of nitrogen gas, such that the volume of the first substance is equal to about 25% to 50% of a total volume of the first compartment, with a remaining volume of the first compartment being filled with a mixture of nitrogen gas and air; and
the second compartment further contains a volume of nitrogen gas, such that the volume of the second substance is equal to about 25% to 50% of a total volume of the second compartment, with a remaining volume of the second compartment being filled with a mixture of nitrogen gas and air.

16. A multi-compartment pouch apparatus comprising:
a pouch portion constructed out of a first sheet and an opposing second sheet of a substantially flat, flexible laminate material secured to one another about a sealed perimeter edge thereof, the first sheet and second sheet of a substantially transparent laminate material cooperating to define a pouch cavity therebetween;
the laminate material comprising:
an innermost layer constructed out of a polyethylene material configured for being heat-sealable, biocompatible for food contact, and providing a compliant interface that is capable of being welded reproducibly;
a second layer, adjacent to the innermost layer, constructed out of a polyamide material configured for providing puncture resistance, tear resistance, and flexural toughness to the laminate material;
a third layer, adjacent to the second layer, constructed out of an aluminum foil material configured for providing an oxygen barrier and light barrier to the laminate material; and
an outermost layer, adjacent to the third layer, constructed out of a polyethylene terephthalate material configured for providing tensile strength, dimensional stability under heat, and resistance to creep to the laminate material;
a frangible seal spanning the perimeter edge of the first sheet and second sheet of laminate material so as to divide the pouch cavity into a first compartment and a separate second compartment, the frangible seal formed as a heat seal between the innermost layer of each of the first sheet and second sheet of laminate material, without use of any adhesive materials, such that an interfacial bond between the innermost layer of each of the first sheet and second sheet of laminate material is structurally weaker than a cohesive strength of each innermost layer and of the sealed perimeter edge;
the first compartment containing a volume of a powdered infant formula along with a volume of nitrogen gas;
the second compartment containing a volume of water along with a volume of nitrogen gas;
a spout in fluid communication with the pouch cavity for selectively dispensing the powdered infant formula and water therefrom;
a cap removably engageable with the spout; and
a storage sleeve within which the pouch portion is temporarily positioned during storage and transport, the storage sleeve constructed out of a substantially opaque material configured for blocking light;
whereby, during use of the apparatus, upon the pouch portion being removed from the storage sleeve and external manual pressure subsequently being applied to the first compartment or second compartment, the frangible seal separates cleanly and uniformly along a length of the frangible seal, turning the first compartment and second compartment back into the single pouch cavity, and causing the powdered infant formula to mix with the water prior to the cap being removed from the spout, without introducing extraneous materials or residues into the pouch cavity.

17. A method for manufacturing and filling the multi-compartment pouch apparatus of claim comprising the steps of, with the spout already engaged with the pouch portion, the cap already engaged with the spout, and the frangible seal already dividing the pouch cavity into the first compartment and separate second compartment within the pouch portion:
positioning the apparatus in a dehumidified environment;
temporarily inserting a first dispensing nozzle into the perimeter edge of the pouch portion so as to be in fluid communication with the first compartment;
flushing the first compartment with a volume of nitrogen gas via the first dispensing nozzle so as to purge the first compartment of oxygen and moisture;
with oxygen and moisture displaced from the first compartment, introducing a predetermined volume of the powdered infant formula into the first compartment via the first dispensing nozzle;
flushing the first compartment again with a volume of nitrogen gas via the first dispensing nozzle so as to purge the first compartment of oxygen and moisture;
retracting the first dispensing nozzle from the perimeter edge of the pouch portion;
sealing the perimeter edge of the pouch portion proximal to the first compartment so as to create a permanent seal between the first sheet and second sheet of laminate material;
temporarily inserting a second dispensing nozzle into the perimeter edge of the pouch portion so as to be in fluid communication with the second compartment;
flushing the second compartment with a volume of nitrogen gas via the second dispensing nozzle so as to purge the second compartment of oxygen and moisture;
with oxygen and moisture displaced from the second compartment, introducing a predetermined volume of water into the second compartment via the second dispensing nozzle;
flushing the second compartment again with a volume of nitrogen gas via the second dispensing nozzle so as to purge the second compartment of oxygen;
retracting the second dispensing nozzle from the perimeter edge of the pouch portion;
sealing the perimeter edge of the pouch portion proximal to the second compartment so as to create a permanent seal between the first sheet and second sheet of laminate material;
sterilizing an outer surface of the pouch portion;
inserting the pouch portion into the storage sleeve;
flushing the storage sleeve with a volume of nitrogen gas so as to purge the storage sleeve of oxygen and moisture; and
sealing the storage sleeve.

18. The method of claim 17, wherein:
the step of introducing a predetermined volume of the powdered infant formula into the first compartment via the first dispensing nozzle further comprises the step of introducing a volume of powdered infant formula in an amount equal to about 25% to 50% of a total volume of the first compartment, with a remaining volume of the first compartment being filled with a mixture of nitrogen gas and air; and
the step of introducing a predetermined volume of water into the second compartment via the second dispensing nozzle further comprises the step of introducing a volume of water in an amount equal to about 25% to 50% of a total volume of the second compartment, with a remaining volume of the second compartment being filled with a mixture of nitrogen gas and air.

19. The method of claim 17, further comprising the step of, upon both the first compartment and second compartment being filled with the respective powdered infant formula and water, sealing the entire perimeter edge of the pouch portion once more to better ensure a leak-proof integrity along the entire perimeter edge.

20. The method of claim 17, wherein the step of sterilizing an outer surface of the pouch portion further comprises the step of sterilizing the outer surface of the pouch portion using one or both of UV light exposure and an antimicrobial spray.
